(19) United States
(12) Patent Application Publication
(10) Pub. No.: US 2012/0152223 A1
(43) Pub. Date: Jun. 21, 2012

(54) BAKING DEVICE AND METHOD FOR OPERATING A BAKING DEVICE

(75) Inventors: Ulrich Sillmen, Guetersloh (DE); Alexandrine Ziethen, Lippstadt (DE)

(73) Assignee: MIELE & CIE. KG, Guetersloh (DE)

(21) Appl. No.: 13/329,522

(22) Filed: Dec. 19, 2011

(30) Foreign Application Priority Data
Dec. 20, 2010 (DE) 10 2010 061 339.8

(51) Int. Cl. A21B 1/00; A21B 3/00

(52) U.S. Cl. 126/21 A; 126/19 R

(57) ABSTRACT

A baking device including a baking chamber, a heat source configured to heat the baking chamber, a baking chamber door that closes the baking chamber, and an opening mechanism configured to automatically open the baking chamber door so as to rapidly cool off the baking chamber.

### CROSS REFERENCE TO RELATED APPLICATIONS

This application claims priority to German Patent Application No. DE 10 2010 061 339.8, filed Dec. 20, 2010, which is hereby incorporated by reference herein.

### FIELD

The invention relates to a baking device with an opening mechanism, especially for automatically opening the baking chamber, and it also relates to a method for operating such a baking device.

### BACKGROUND

Baking devices are constantly being refined in order to meet the ever-rising requirements in terms of their energy efficiency. For this purpose, especially the insulation of the baking chamber of baking devices is constantly being improved. As a consequence, the temperature in the baking chamber only drops very slowly, even after the heating element has been completely switched off.

In some situations, however, such temperature stability is not desirable or is even detrimental. For example, if a baking device has a self-cleaning function that operates on the principle of pyrolysis, it can, in fact, take a very long time before the baking device is once again ready for use, since the temperature in the baking chamber has to fall below a certain level before the baking chamber door can be opened again. This hampers the operating convenience.

However, even with normal baking tasks such as, for example, baking a cake, the slow drop of the baking chamber temperature can be undesirable. Once the baked foods have browned to the desired extent, the heating elements automatically switch off if, for instance, an automatic program is being used. However, since the residual heat in the baking chamber only subsides slowly, the baked food can continue to brown, which is undesired. As a result, in the worst case scenario, the food might become inedible since it becomes too browned if the user does not promptly remove the food from the oven or at least open the baking chamber door.

During a baking process, it can also be advantageous to cool off the baking chamber rapidly. If one uses an oven, for example, to sear a roast, the oven has to be initially set at a very high temperature in order to achieve the desired browned exterior of the roast. However, then the temperature in the baking chamber has to be rapidly lowered to a relatively low level in order to continue roasting the meat at a low temperature for several hours. In such a case as well, the user has to actively intervene in the roasting process and has to, for instance, open the door of the baking chamber in order to let it cool off.

Such an intervention is inconvenient for the user. Furthermore, intervening in the roasting process, for example, opening the door, can easily be forgotten, or else it is not even possible in certain situations when the user happens to be busy doing other things. This can have a very negative effect on the roasting results.

German patent application DE 10327420 A1, for example, describes the use of a vapor device for automatically cooling off the baking chamber. The vapor device applies liquid onto the propeller of the fan of the baking device, as a result of which the rotational movement of the fan propeller introduces small droplets of liquid into the baking chamber. The baking chamber is cooled off by the cooling that results when the droplets evaporate. A drawback of such a method for cooling the baking chamber, however, is that the moisture level in the baking chamber is considerably changed. In certain cases, this can cause a deterioration of the baking results.

Another method for cooling the baking chamber is described in German patent application DE 102008012681 A1. Here, by employing a specific valve, the hot air fan of the baking chamber is used either to circulate the air in the baking chamber or to draw in fresh air. In this process, a counter-current of incoming fresh air and outgoing moist circulating air from the baking chamber is supposed to be generated in the same conduit. A drawback here is, however, that the fresh air is drawn in from the negative pressure area behind the hot air fan. Consequently, only a small air stream can be used for cooling purposes, as a result of which the cooling requires a long time, during which the baking process continues.

### SUMMARY

In an embodiment, the present invention provides a baking device including a baking chamber, a heat source configured to heat the baking chamber, a door configured to close the baking chamber, and an opening mechanism configured to automatically open the door so as to encourage rapid cooling of the baking chamber.

### BRIEF DESCRIPTION OF THE DRAWINGS

Exemplary embodiments of the present invention are described in more detail below with reference to the drawings, in which:

FIG. 1 is a schematic perspective view of a baking device according to an embodiment of the invention which is configured as an oven; and

FIG. 2 is a schematic depiction of a baking device in a sectional view with an opening mechanism for rapidly cooling the baking chamber.

### DETAILED DESCRIPTION

In an embodiment, the present invention provides a baking device that reliably and rapidly allows effective cooling of the baking chamber, even in well-insulated ovens.

The baking device according to an embodiment of the invention has at least one baking chamber that can be heated by at least one heat source. For purposes of retaining the heat in the baking chamber, at least one door that closes the baking chamber is provided in order to close the baking chamber. In order to allow a rapid cooling of the baking chamber, there is also at least one opening mechanism that is at least suited and configured to automatically open the baking chamber door.

A baking device configured in this manner offers many advantages. A major advantage is that opening the baking chamber door is an effective way to rapidly cool off the baking chamber. In particular, the automatic opening of the door is a major advantage since it can no longer happen that the user forgets to open the door in order to cool off the baking chamber. Even in the case of long and/or complex baking processes, which are regulated, for example, by automatic programs with highly fluctuating temperature profiles, the user no longer has to remain in the immediate vicinity of the baking device during the entire procedure. Any manual opening of the door that might be required for rapidly cooling off the baking chamber can be carried out simply and automatically by the baking device according to the invention.

Here, it is also advantageous that the door can be closed again by the opening mechanism. This makes it possible to briefly open the baking chamber during a baking process for cooling purposes and to subsequently close it again. This is especially helpful if a baking process has to be started at a very high heat setting and then has to be baked further at a low baking temperature.

The automatic opening of the door is also especially useful at the end of a baking process. Thus, a baking process can be started and a user no longer has to take the finished food, for example, a cake, out of the oven immediately after the end of the baking process. The door is automatically opened by at least a gap, as a result of which the baking chamber can cool off.

In order to be able to effectively use the automatic opening of the door, it is advantageous for a control unit to be provided that is connected to the opening mechanism. In this manner, the function of the rapid cooling of the baking chamber can also be easily integrated into existing operating cycles or can be linked to various functions.

In order to also allow the rapid cooling function to be regulated manually, it is preferred for an actuation means to be provided that is connected to the opening mechanism. It is also preferred for the actuation means to be connected to the control unit, and for the control unit to activate the opening mechanism when the actuation unit is activated.

The opening mechanism can be implemented by numerous operating principles. It is especially preferred for the opening mechanism to function with a motor, hydraulically, pneumatically and/or magnetically. The door can be opened and closed again, for example, by the movement of a toothed rack. It is also useful for the door to be opened by means of a pressure cylinder. In this case, the door can then be closed again by relieving the pressure cylinder. It is also possible to provide a spring that pulls the door back into its closed position again. However, other suitable mechanisms such as, for example, a motorized rotating shaft on the door, can also be used to open and close the door of the baking chamber.

In this context, for design-related reasons, preference is also given to installing the opening mechanism to be installed in the least conspicuous manner possible. For this purpose, opening mechanisms such as, for example, toothed racks or pressure cylinders can be arranged in the columns of the housing of the baking device. This means that the opening mechanisms would be installed so as to remain essentially concealed.

Depending on the baking chamber temperature, it can be helpful and/or necessary to open the door to a greater or lesser extent. Therefore, in preferred embodiments, it is provided that the opening mechanism is suited and configured to select different opening widths. For this purpose, for example, a rod or a sliding element that is provided to open the door can be extended by different distances in order to yield different gap widths between the door and the baking chamber opening. Here, the door does not have to be opened particularly far. A gap of between 0.5 cm and 5 cm, preferably between 1 cm and 3 cm, and especially preferably a gap of 1.9 cm is usually sufficient to achieve an effective cooling of the baking chamber. Of course, smaller gap widths as well as larger gap widths, all the way to a complete opening of the oven door, are likewise conceivable.

In order to prevent too much air and/or air that is too hot from streaming out of the baking chamber, a process in which especially an abrupt escape of hot, moist air is to be avoided, it is preferred for the baking chamber door to be opened incrementally by the opening mechanism. Such an incremental opening can more effectively prevent the control panel from heating up and/or condensate from forming on the control panel or on other parts of the baking device. In particular, it is also possible for the door to open in a continuous process.

In order to achieve an especially effective cooling of the baking chamber, a fan can be provided that is suited and configured to expel the hot air from the baking chamber. Particularly in the case of large temperature differentials over a short period of time, for example, if the baking chamber is cooled from 220° C. to 120° C. within about 3 minutes, the assistance of such a fan can be advantageous. For instance, this fan can be an existing circulation fan that mixes hot and cold air in the baking chamber, that forces air along the walls of the baking chamber walls for cooling purposes, and that expels hot air out of the baking chamber.

It is also preferable to use at least one fan that can also be positioned externally. Here, preference is especially given to a fan that is arranged outside of the baking chamber and that is connected to the baking chamber either directly or via a connecting piece. In this manner, the fan can feed cold fresh air into the baking chamber, and this cold air forces the hot air out of the baking chamber through the door that has been opened by at least a gap. As a result, an especially effective cooling can be achieved. It is also preferred for cold fresh air to be fed into the baking chamber before the door is automatically opened by the opening mechanism. This makes it possible to effectively prevent hot vapors from escaping abruptly.

In order to achieve a good coordination between the opening of the door and the assistance by the air stream, the fan(s) can also be connected to the control unit.

In preferred embodiments, at least one sensor is associated with the opening mechanism and/or with the control unit. In this manner, on the one hand, the opening status of the door can be ascertained and, on the other hand, the size of the gap can be adapted to a given situation. If the baking chamber is particularly hot, for example, after a pyrolytic self-cleaning procedure, it can be beneficial to open the baking chamber incrementally and slowly in order to avoid an abrupt escape of extremely hot air.

The method according to the invention is suited for operating a baking device having at least one thermally heatable baking chamber. Here, at least one door that closes the baking chamber is provided in order to close the at least one baking chamber. At least one opening mechanism is provided for the at least one baking chamber door, by means of which the baking chamber door can be opened automatically by at least a gap in order to assist with the rapid cooling of the baking chamber.

A method configured in this manner is advantageous. An advantage is that the door of the baking chamber can be opened automatically by means of the opening mechanism by at least a gap. The automatic opening of the baking chamber door is much more convenient for users since they no longer have to take the finished food out of the baking chamber immediately after the end of the baking procedure.

Baking devices have now become so well insulated that food would continue to bake, even after the heat source has been switched off entirely. As a result, in the worst case scenario, the food might become inedible. Automatic programs for baking foods in combination with the method according to the invention make it possible, for instance, to start a baking procedure such as, for example, the baking of a cake, without having to remain in the vicinity of the baking device in order to be able to remove the cake from the oven once it has reached the desired brownness or else so as to able to open the door by hand.

Preferably, the baking chamber door is only automatically opened after a predefined period of time or once the oven has reached a predefined temperature. This can prevent air that is too hot or too moist from escaping abruptly from the baking chamber. As a result, it is possible to more effectively prevent the control panel of the baking device, for example, from heating up or else condensate from being formed. It is also conceivable for the baking chamber door to first be opened only by a given increment, and then to be opened to the gap width intended for the cooling off only once a predefined period of time has elapsed or once the baking chamber has reached a predefined temperature. Especially advantageously, in addition to opening the baking chamber door, at the same time, the hot air fan or the fan outside of the baking chamber blows the cold air from the outside into the baking chamber. As an alternative, in addition to opening the baking chamber door, at the same time, the external fan and the hot air fan can be operated.

Especially after a pyrolytic self-cleaning procedure, it can be beneficial to wait for a certain period of time before the baking chamber is opened. For this purpose, it is possible to employ, in particular, values detected by one or more sensors that are used, for example, to measure the baking chamber temperature or the air moisture.

In another preferred embodiment, the automatic opening of the baking chamber door is integrated into an operating cycle. Here, the opening of the door can constitute the end of a cycle in order to prevent the food from being baked further. However, it is also conceivable to provide the opening of the door during a baking cycle. Particularly during the roasting of large pieces of meat such as, for example, a roast, the food could be seared at very high temperatures directly in the oven until the exterior of the roast has achieved the desired level of brownness. Subsequently, the baking chamber has to be cooled off as rapidly as possible to a low roasting temperature. This could effectively be achieved by an automatic opening of the door.

It is also preferable for the opening mechanism to be controlled manually so that the baking chamber can be cooled off as desired.

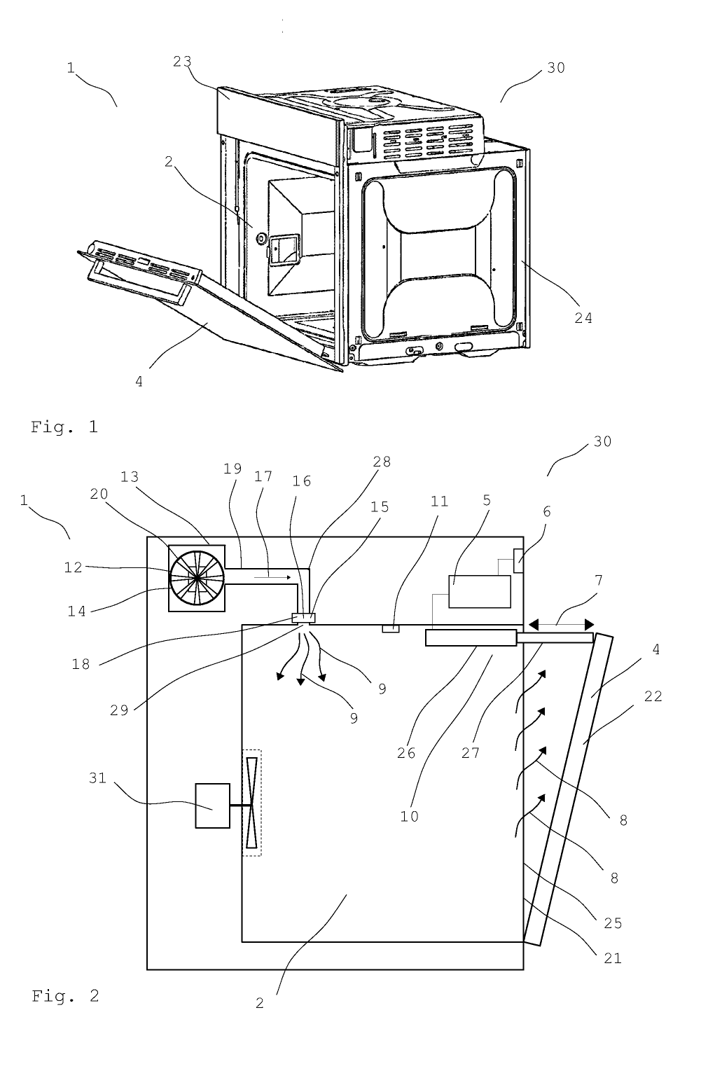

FIG. 1 shows a baking device 1 according to the invention, which is configured here as an oven 30 for installation into a kitchen cabinet. The oven 30 comprises a housing 24 where a baking chamber 2 is arranged which can be closed with a door 4 and in which food can be prepared using various operating cycles. Among other things, various modes of operation can be selected by means of a control panel 23, which is only shown schematically here. In this process, various heat sources 3 can be used to prepare the foods. For example, circulating air, top heat, bottom heat and a broiler function can be used. The temperature can also be adjusted. The control panel 23 can be configured as a touch panel or else it can comprise control elements (not shown here).

Since the demands made of household appliances in terms of energy efficiency are steadily on the rise, the baking device 1 and especially the baking chamber 2 are very well insulated, as a result of which the heated baking chamber 2 only loses the generated heat very slowly, even after the heat source 3 has been switched off. This is a great advantage for the energy balance of a baking device 1, but in some situations, it entails drawbacks as well.

For example, a user has to remove the food immediately or, in the case of an automatic program that automatically detects when the food is ready, has to remove the food as soon as it had finished baking in order to prevent it from continuing to brown or even from burning. Optionally, the baking chamber door has to be opened by hand and, in particular, the shelf that holds the food also has to be pulled out as far as possible so as to let the hot air escape from the baking chamber. In particular, the baking chamber walls have to be cooled off. They store much more heat than the hot baking chamber air itself.

Even if a very high temperature is used initially to heat the baking chamber air and walls, which subsequently has to be rapidly lowered, until now, the user has had to intervene. This is not very practical for a user. Moreover, for example, the opening of the door at the end of a baking process can easily be forgotten. Especially when automatic programs are used, it would be very convenient for users not to have to intervene in the baking process after the program has been started.

The convenience for the user can also be impaired in conjunction with the pyrolytic self-cleaning procedure. Once the device has completed the pyrolytic self-cleaning procedure, it can take a very long time before the baking device is once again ready to be used. The reason is that, for safety reasons, the door can only be opened again below a certain temperature, which can take a long time when it has to cool off from temperatures as high as 500° C.

In order to allow a rapid cooling of the baking device 1, so that the baking chamber 2 cools off rapidly but also reliably, an opening mechanism 10 is provided as shown in FIG. 2 that is suited and configured to open the baking chamber door 4 by at least a gap 7. Intervention by the user is then no longer necessary since the opening mechanism 10 can automatically open the baking chamber door 4.

The opening mechanism 10 can be made in all kinds of configurations. For instance, the opening mechanism 10 can be operated by a motor that, for example, moves a rod and thus pushes the door 4 open by a gap 7. A hydraulic, pneumatic and/or magnetic mechanism is also advantageous for the configuration of the opening mechanism 10.

Other suitable mechanisms such as, for example, a motor-driven rotating shaft on the door, can be provided to open and close the baking chamber door. Therefore, for every kind of opening mechanism 10, for design-related reasons, it is preferable for the opening mechanism to be installed in the least conspicuous manner possible. For this purpose, opening mechanisms 10 such as, for example, toothed racks or pressure cylinders can be arranged in the columns of the housing 24 of the baking device. This means that the opening mechanisms 10 would be installed so as to remain essentially concealed.

In the embodiment shown in FIG. 2, the opening procedure is carried out by a controllable pressure cylinder 26 that opens the door 4 by a certain distance by means of a rod 27. Here, different opening widths 7 can be selected by the opening mechanism 10. An especially preferred opening width 7 is between 0.5 cm and 5 cm, whereby a gap 7 of 1.9 cm has been set in FIG. 2. Larger and smaller opening widths 7 can also be advantageous.

The hot air 8 can escape from the baking chamber 2 rapidly and effectively through the slightly opened door 4, as a result of which the baking chamber 2 cools off. Once the desired temperature has been reached, the rod 27 can move back into the cylinder 26, as a result of which the door 4 is closed again. The necessary force to close the door 4 can come from the door 4 itself, or else it is also conceivable for a pulling mechanism (not shown here in greater detail) to be provided such as, for example, a spring that pulls the door 4 back against the baking chamber opening 25.

In the embodiment shown here, a control unit 5 is provided so that different opening widths 7 of the opening mechanism 10 can be selected. Said control unit 5 controls the automatic opening of the door 4 and can also integrate the automatic opening of the door 4 into various operating cycles.

A manual rapid cooling of the baking chamber 2 is also possible since an actuation means 6 is provided that can actuate the opening mechanism 10. This can be done either directly or else via the control unit 5.

Additional vents 21 can also be provided on the baking chamber through which the hot air 8 can escape from the baking chamber 2. Such a vent 21 is then fitted with a closing mechanism 22 by means of which said vent 21 can be opened and closed automatically. An advantageous position for an additional vent 21 would be, for example, on the side and/or rear area of the baking chamber 2.

Furthermore, in the baking device 1 shown in FIG. 2, at least one sensor 11 is provided that can determine, for example, the position of the door 4, the temperature of the baking chamber 2 and other parameters. On the basis of the values detected by the sensor 11, the control unit 5 can, for example, prevent the opening of the door 4 or can allow it to take place only incrementally if, for instance, the temperature in the baking chamber 2 is still above a critical value. Then the door 4 would at first be opened by just a small gap 7, so as to prevent an abrupt escape of excessively hot vapors. After an initial cooling, the door 4 can then either be opened immediately to the desired opening width 7 or else gradually in order to cool off the baking chamber 2 as rapidly as possible.

In order to cool off the baking chamber 2 even more effectively, the hot air fan 31 or another fan of the baking device 1, for example, can assist with the cooling. The baking chamber 2 can be cooled off especially effectively if a fan 20 is arranged outside of the baking chamber 2, which is suited and configured to feed cold fresh air 9 into the baking chamber 2. On the one hand, the cold air 9 effectively cools the baking chamber 2, and on the other hand, the incoming air 9 forces the hot air 8 out of the baking chamber, as a result of which the baking chamber 2 can be cooled off rapidly.

In the embodiment shown here, the fan 20 is configured as a radial fan 12, ensuring that the air is conveyed very effectively. Here, especially air volumes of more than 800 liters per minute are preferred. The fan shown here can convey about 1000 liters per minute. Larger or smaller air volumes can be advantageous, depending on the application purpose.

In preferred embodiments, the fan 20 is also configured as a direct current fan 14, as a result of which gradual regulation is possible. Here, the control unit 5 can also control the fan 20, whereby, in the embodiment shown here, the sensor 11 can also detect the status of the fan 20.

The fan 20 is arranged here in a housing 13 and it blows the cold fresh air 9 through a connection channel 19 into the baking chamber. In order for the air stream 17 not to become too weak, preferably a maximum of one elbow 28 is provided in the connection channel 19. Of course, several elbows can also be provided, but as a result, a stronger fan 20 would be needed. Furthermore, it should be ensured that the connection channel 19 is not configured excessively long. In order not to detrimentally affect the power of the fan 20, a length of less than 30 cm is preferred. Shorter or longer connection channels 19 are also conceivable, but in this case, there might be a need to adapt the fan 20 in order to ensure sufficient cooling.

In the embodiment shown in FIG. 2, the connection channel also has a gasket 15 between the fan 20 and the baking chamber 2. Here, a flap device 16 is provided that closes the access 29 to the baking chamber 2. The flap device 16 is configured in such a way that it is held in a closed position, for instance, by means of a spring, when the fan 20 is not switched on. The air stream 17 of the fan 20 can then press the flap device 16 open and thus free the access 29 to the baking chamber. Such a flap device 16 prevents hot air 8 from escaping out of the baking chamber 2 into the area between the baking chamber 2 and the housing 24.

The fan 20 can also be used selectively, for example, by the flap device 16, in order to cool electric and electronic components or to blow air into the baking chamber in order to rapidly cool it off, or for both at the same time.

The baking device 1 can, however, also have an external fan 20 for rapid cooling in addition to the otherwise common and required components (not shown here), namely, the cooling fans and the exhaust fans of the baking device 1.

In other embodiments, an electronically controlled flap device can also be provided. It could be connected, for instance, to the control unit and could be opened and closed on an as-needed basis. Other gaskets 15 that function essentially as valves are also conceivable.

Furthermore, a few baking devices have a vent, for example, in the upper area of the baking chamber, via which moisture is removed from the baking chamber during the baking process. This vent can be configured as a perforated plate. Since the fan 20 can perform the function of removing moisture from the baking chamber, it is especially also possible to use the perforated plate intended for dehumidifying the baking chamber as the access 29 for the air stream 17. It might be the case that the size of the perforated plate will have to be adapted in such a way that a sufficient volume of cold air 9 can be forced into the baking chamber 2. In the embodiment shown here, an access surface area of 11 cm2 is provided, which corresponds here to a perforated plate with a diameter of 5.2 cm and with about 28 holes. This also makes it possible to retrofit baking devices with a fan 20 for cooling off the baking chamber 2.

For the rest, it falls within the realm of expertise of the person skilled in the art to modify the embodiments described in ways not shown here in order to achieve the described effects, without leaving the scope of the invention.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

1 baking device
2 baking chamber
3 heat source
4 baking chamber door
5 control unit
6 actuation means
7 opening width/gap
8 air expelled from the baking chamber
9 fresh air
10 opening mechanism
11 sensor
12 radial fan
13 housing
14 direct-current fan
15 gasket
16 flap device
17 air stream
18 electronically controlled flap device
19 connection channel
20 fan
21 vent
22 closing mechanism
23 control panel
24 baking device housing
25 baking chamber opening
26 pressure cylinder
27 rod
28 elbow
29 access
30 oven
31 hot air fan

What is claimed is:

1: A baking device comprising:
at least one baking chamber;
at least one heat source configured to heat the at least one baking chamber;
at least one door configured to close the baking chamber; and
at least one opening mechanism configured to automatically open the at least one door so as to encourage rapid cooling of the baking chamber.

2: The baking device recited in claim 1, further comprising a control unit connected to the opening mechanism.

3: The baking device recited in claim 2, further comprising an actuating device connected to at least one of the opening mechanism and the control unit.

4: The baking device recited in claim wherein operation of the opening mechanism is performed at least one of hydraulically, pneumatically, magnetically and with a motor.

5: The baking device recited in claim 1, wherein the opening mechanism is configured to select different opening widths.

6: The baking device recited in claim 1, wherein the opening mechanism is configured to open the door incrementally.

7: The baking device recited in claim 1, further comprising at least one fan configured to force air out of the baking chamber.

8: The baking device recited in claim 1, further comprising a fan disposed outside of the baking chamber and configured to feed fresh air into the baking chamber.

9: The baking device recited in claim 1, wherein at least one sensor is associated with at least one of the opening mechanism and the control unit.

10: A method for operating a baking device comprising:
providing a baking device including at least one thermally heatable baking chamber, at least one door configured to close the at least one baking chamber and at least one opening mechanism configured to open the at least one door; and
automatically opening the at least one door by at least a gap so as to encourage rapid cooling of the at least one baking chamber.

11: The method recited in claim 10, wherein the opening of the door is performed only after a predefined period of time.

12: The method recited in claim 10, wherein the opening of the door is performed only once the baking chamber has reached a predefined temperature.

13: The method recited in claim 10, wherein the opening of the door includes first opening the door by only a given increment and then further opening the door to a gap width suitable for cooling off the baking chamber only once a predefined period of time has elapsed or once the baking chamber has reached a predefined temperature.

14: The method recited in claim 10 further comprising, at the same time as opening the door, blowing cold air from outside into the baking chamber using at least one of a hot air fan and a fan disposed outside the baking chamber.

15: The method recited in claim 14, wherein the blowing cold air utilizes the hot air fan and the fan disposed outside the baking chamber.

16: The method recited in claim 10, wherein the automatic opening of the door is an integrated part of an operating cycle.

17: The method recited in claim 10, wherein the opening mechanism is controlled manually.
